(19) United States
(12) Patent Application Publication
(10) Pub. No.: US 2026/0321687 A1
(43) Pub. Date: Oct. 15, 2026

(54) PREHEAT FOR HTPEM FUEL CELL COOLING AIR

(71) Applicant: ZeroAvia Ltd, Cirencester (GB)

(72) Inventor: Charles Robert Cumpsty, Cirencester (GB)

(21) Appl. No.: 19/186,499

(22) Filed: Apr. 22, 2025

(30) Foreign Application Priority Data
May 9, 2024 (GB) 2406521.1

(51) Int. Cl. H01M 8/04007; B64D 27/355; H01M 8/04014; H01M 8/04111; H01M 8/04291; H01M 8/0432; H01M 8/04492; H01M 8/04537; H01M 8/04701; H01M 8/1231

(52) U.S. Cl. CPC H01M 8/04067; B64D 27/355; H01M 8/04014; H01M 8/04059; H01M 8/04111; H01M 8/04291; H01M 8/0432; H01M 8/04492; H01M 8/04559; H01M 8/04716; H01M 8/04723; H01M 8/04731; H01M 8/1231; H01M 2250/20

(57) ABSTRACT

An integrated hydrogen-electric power system for a propeller-driven aircraft includes a hydrogen fuel source; an FC stack; an air compressor configured to introduce compressed air into a cathode side of the FC stack; a heat exchanger configured to warm ram air for cooling the FC stack; and an elongated shaft configured to support the air compressor system and a turbine. The heat exchanger is configured to condense liquid water from a cathode exhaust stream from the FC stack. A liquid water sprayer is provided configured to spray condensed liquid water recovered from the cathode exhaust stream onto the FC stack to cool the FC stack by evaporative cooling. In another embodiment, a heat exchanger is provided to extract waste heat from the electric propulsion system and/or the gear box, to warm ram air for cooling the FC stack.

### CROSS-REFERENCE TO RELATED APPLICATIONS

This application claims benefit to UK Application Serial No. 2406521.1, filed May 9, 2024, the entire contents of which are incorporated herein by reference.

### TECHNICAL FIELD

The present disclosure relates to heat management of fuel cells. The disclosure has particular utility for heat management of fuel cells (FCs) such as High Temperature Proton Exchange Membrane (HTPEM) FC power systems onboard vehicles including aircraft and will be described in connection with such utility, although other utilities are contemplated.

### BACKGROUND AND SUMMARY

This section provides background information related to the present disclosure which is not necessarily prior art, and is related to the present disclosure. This section provides a general summary of the disclosure and is not a comprehensive disclosure of its full scope or all its features. An FC is an electrochemical cell that converts chemical energy into electrical energy by spontaneous electrochemical reduction-oxidation (redox) reactions. FCs include an anode and a cathode separated by an ionically conductive electrolyte. During operation, a fuel (e.g., hydrogen) is supplied to the anode and an oxidant (e.g., oxygen or air) is supplied to the cathode. The fuel is oxidized at the anode, producing positively charged ions (e.g., hydrogen ions) and electrons. The positively charged ions travel through the electrolyte from the anode to the cathode, while the electrons simultaneously travel from the anode to the cathode outside the cell via an external circuit, which produces an electric current. The oxidant supplied to the cathode is reduced by the electrons arriving from the external circuit and combines with the positively charged ions to form water. The reaction between oxygen and hydrogen is exothermic, generating heat that needs to be removed from the FC.

FCs may be used as power sources for electric motors of electric vehicles and hybrid electric vehicles, including aircraft. In such applications, FCs oftentimes are arranged in stacks of multiple cells and connected in a series or parallel arrangement to achieve a desired power and output voltage. Cooling systems for FC-powered vehicles oftentimes use an airflow generated during movement of the vehicle as a heat transfer medium. For example, an ambient airflow may be directed from outside the vehicle through an air intake of the vehicle and through one or more heat exchangers disposed within the vehicle to cool a secondary fluid circulated through the FC. An airflow generated in this manner is oftentimes referred to as ram air and, when ram air is used as a cooling medium in a vehicle, the vehicle may experience increased drag, which may reduce the energy efficiency of the vehicle.

Cooling an FC to power an airplane presents significant technical challenges, particularly in the case of HTPEM FCs. One challenge is that HTPEM FCs often are air cooled, requiring large air mass flow rates (which cause drag). A second challenge is that HTPEM bipolar plates have strict lower limits on the air temperature for cooling, meaning the cooling air may require preheating before contact with the HTPEM FC stacks which have a minimum cooling temperature in the range of approximately 0-40° C. A further challenge is that HTPEM FC-powered aircraft require FC power systems which are lightweight, low volume, and operate efficiently over a wide range of operating conditions.

Existing solutions for cooling HTPEM FCs focus on using compressed air to cool the HTPEM FCs. Given operating temperature requirements, the usual design choice is to use a compressor to condition the air to a desired temperature, and to recover energy from the compressed air with a cooling air turbine. However, this design is unattractive since a large compressor is required which results in a large weight and drag penalty. Also, in hot conditions the compressed air may require cooling before introduction into the HTPEM FCs, which is thermodynamically inefficient. Adding a heat exchanger to condition the cooling airflow adds weight and drag, while using a resistive heater to heat the airflow to a desired working temperature requires a huge amount of energy in cold conditions. Employing evaporative cooling is another option but requires storage of water onboard the vehicle or another heat sink to condense water from the HTPEM FC cathode exhaust.

Referring to FIG. 1, an HTPEM FC power system architecture 8 for cooling a HTPEM FC stack 16 employs a first, relatively large compressor 10 driven by electric motor 11 to compress incoming cooling air and raise the temperature of the incoming cooling air to meet the operating temperature requirements for the HTPEM FC stack 16.

The cooling air from compressor 10 is passed via cooling air inlet 14 to HTPEM FC stack 16 where the cooling air is used to maintain the HTPEM FC stack 16 at a desired operating temperature. The cooling air exhaust 18 from the HTPEM FC stack 16 is then passed to a turbine 20, in which some of the thermal energy in the cooling air exhaust 18 from the HTPEM FC 16 is recovered. Turbine 20 is mechanically connected to compressor 10 via a shaft 22.

Hydrogen gas (H₂) is fed from an H₂ fuel tank 24 to an anode inlet 26 of HTPEM FC stack 16, where the H₂ is reacted with oxygen in air supplied to the cathode inlet 28 of the HTPEM FC stack 16 from a second electrically driven air compressor 30, to produce electricity. Depleted air and water vapor from the cathode exhaust and unreacted H₂ from the HTPEM FC stack 16 is passed via conduit 34 to an anode tail oxidizer (ATO) 36 in which unreacted H₂ in the anode exhaust is combusted. The resulting exhaust from ATO 36, which includes moisture produced by combustion of the H₂ in the ATO 36 as well as moisture produced in the cathode exhaust HTPEM FC stack 16 is then passed to a turbine 38 which is mechanically connected to compressor 30 via a shaft 40. The exhaust from turbine 38 is then combined with cooler air exhaust 18 and also passed to turbine 20, in which some of the thermal energy contained in the turbine 38 exhaust also is recovered.

In the HTPEM FC power system architecture 8 of FIG. 1 compressor 10 must work at over a large range of operating points. For example: at sea level for a 2 MW class powertrain, compressor 10 must compress about 30 kg/s mass flow of air at a very low-pressure ratio (about 1.1). At altitude, to heat the air to a desired operating temperature, compressor 10 requires a much higher-pressure ratio (2.6) but a lower mass flow rate due to the reduced power requirements of cruise (about 15 kg/s). These operating points are on opposite sides of a compressor efficiency map, which means that compressor 10 is required to operate over significant power ranges, and accordingly suffers from high weight and low efficiencies.

Referring to FIG. 2, there is illustrated another HTPEM FC power system architecture 50 for cooling a HTPEM FC. The FIG. 2 system architecture eliminates a need for a large electrically driven cooling compressor, by employing wastewater 64 from the cathode exhaust of the HTPEM FC stack 56 to provide evaporative cooling via a semi-open loop cycle. In this HTPEM FC power system architecture 50, the FCs in the HTPEM FC stack 56 are sprayed with water that is condensed from the cathode exhaust 54. More particularly, a portion of the humid cathode exhaust 54 from HTPEM FC stack 56 is passed through an air cooled heat exchanger (HEX) 58, where cool free stream airflow 59 enters HEX 58 and picks up heat from cathode exhaust 54, and is then exhausted as hot free stream airflow 61, and moisture in the hot cathode exhaust is cooled and condensed to liquid water. The liquid water is then passed via pump 60 and conduit 62 and sprayed on the HTPEM FC stack 56 to cool the HTPEM FC stack 56. The dry air exhaust 66 from HEX 58 is passed to ATO 36, while a portion of the cathode exhaust also may be recycled to the HTPEM FC stack 56 via conduit 68. The ATO exhaust is then passed to turbine 38 via conduit 39. A feature and advantage of this HTPEM FC power system architecture 50 of FIG. 2 over the system architecture 8 of FIG. 1 is that the large air compressor 10 and its associated turbine 20 are eliminated. However, a technical disadvantage of this system architecture 50 is that the heat sink needed to condense the water (i.e., the external airflow to air heat exchanger 58) is very large and heavy, adding significant drag.

FIG. 3 depicts yet another HTPEM FC power system architecture 70 for cooling a HTPEM FC stack 57. HTPEM FC power system architecture 70 is similar to the FIG. 1 HTPEM FC power system architecture 8. However, in the FIG. 3 HCTEM FC power system architecture 70 cooling water 72 is provided, e.g., for takeoff (TO) and climb, from an onboard water tank 74. Water tank 74 supplements cooling at ground level in order to keep the cooling air mass flow down and keep the cooling compressor 10 operating within a reasonable range. Also, compressor 10 may be made somewhat smaller, potentially reducing weight and drag. And, while there is no drag penalty, this system architecture suffers from a high weight penalty from the mass of water needed to be stored on the aircraft as the system is required to operate in a “go around” flight scenario. If the cooling water is instead generated during flight, this architecture suffers from the same issues as the architecture of FIG. 2, where a significant heat sink is needed to condense the water vapor in the cathode exhaust to liquid water.

In accordance with the present disclosure, we provide a HTPEM FC stack with an air-to-air HEX configured to heat cold ram air before introduction into the HTPEM FC stack. Hot, humid ATO exhaust, comprising an air-steam mixture, after passing through a turbine (or optionally bypassing the turbine) is introduced into the HEX, to heat the cold ram air. The turbine also is used to assist in powering a compressor which pressurizes air for the cathode inlet.

In the process of heating the ram air, water is condensed out of the hot, humid turbine exhaust. This condensed liquid water is then used for evaporative cooling of the HTPEM FC stack. Optionally, in one embodiment a reservoir of liquid water is stored for emergency situations or for high-power operation, when additional cooling is required. Excess condensed liquid water generated by the HEX can be stored in the reservoir.

Unlike the HTPEM FC power system architecture 50 illustrated in FIG. 2, in accordance with the present disclosure cooling air for the HTPEM FC stack is heated using the turbine exhaust. This serves the dual purposes of (1) conditioning the cooling air, and (2) condensing liquid water for cooling. In contrast, the HTPEM FC power system architecture 50 of FIG. 2 performs these functions using separate components: (1) a compressor to condition cooling air, and (2) a HEX to condense liquid water from the exhaust using freestream air.

In an alternative embodiment of the present disclosure, we employ waste heat from the electric propulsion system (EPS) and/or mechanical devices, such as powertrain gear boxes, to preheat the cooling air. However, this waste heat is not nearly enough to reach the desired operating temperatures for the HTPEM FC stack. Typically, this waste heat from the EPS and/or mechanical devices such as powertrain gear boxes may provide only about 10° Celsius of heating. Thus, at temperatures of −30° Celsius at altitude there is still 50° Celsius to go to reach a desired operating temperature of 30° Celsius.

In accordance with another embodiment of the disclosure, cooling air for the HTPEM FC is passed through a HEX for the EPS and mechanical devices such as powertrain gearboxes, where the cooling air picks up a small amount of heat. In one embodiment, the EPS components (e.g. the electric motor) may intentionally be operated in an inefficient manner to generate additional waste heat. Ram air compression, plus the EPS and gearbox waste heat may add sufficient heat to precondition the cooling air to reach the required temperature in some flight phases. However, when waste heat is insufficient, the cooling air may be mixed with warm, moist turbine exhaust. Direct mixing of the cooling air and the turbine exhaust eliminates the need for a HEX between the turbine exhaust and the HTPEM FC cooling air. Mixing can then be discontinued on a hot day which allows the cooling mass flow to be minimized by not increasing the temperature significantly above ambient. Direct mixing of the cooling air stream and the turbine exhaust also results in cooling air which is moist which improves heat capacity and cooling capability of the air. However, liquid water is no longer condensed out of the stream to reduce air mass flow and assist in fringe cooling cases. Alternatively, if it is desired to minimize pressure drop, the EPS HEX may be removed, and air preconditioning can be accomplished by mixing alone.

In alternative embodiments, ATO exhaust may be routed to bypass the turbine, permitting control of the properties of the turbine exhaust flow when even more heat is needed.

A feedback controller is used to regulate the temperature of the HTPEM FC stack cooling air to within allowable limits. Sensor measurements, including HTPEM FC stack temperature, HTPEM FC stack cooling air inlet temperature and humidity, ATO and turbine exhaust temperature, humidity and mass flow and aircraft external air temperature, can be used to adjust turbine speed, turbine bypass mass flow, and mixing mass flow through use of an electronic controller, to achieve a desired temperature of the HTPEM FC stack.

The present disclosure provides several significant advantages over the prior art. Air exiting the cathode contains a significant amount of water that provides extra cooling benefits. If a heat exchanger is used to condense moisture out of the cathode exhaust, the condensed water can be collected and used for cooling the HTPEM FC stack either by spraying the water directly onto the HTPEM FC stack, or by employing FCs having porous bipolar plates which allow for direct evaporative cooling. Condensing and collecting water also allows for extra safety as water generated during flight can be collected and stored to provide for emergency cooling. If direct mixing of the cathode exhaust and cooling air is employed, the moisture in the cathode exhaust will increase the heat capacity of the cooling air flow. This provides an advantage, significantly lowering the amount of cooling airflow needed due to the assistance of evaporative cooling and the higher heat capacity of the air/water mixture.

Also, there is little to no extra drag generated by the system architecture of the present disclosure as compared to system architecture of FIGS. 1-3. While there is a pressure drop across the HEX and HTPEM systems, the density change from heating, due to the high temperature of the humid cooling air exhaust, significantly reduces any extra drag, and actually may generate additional thrust in some cases as can be seen from the following:
Internal drag from a cooling system is calculated as follows:
Drag=mass_flow * (Velocity_in−Velocity_out)
Thus, increasing the velocity out will decrease drag, since Velocity_out is a function of how much total pressure is available after all of the losses.
½*density*Velocity_out\hat{ }2=Ptotal_out
Therefore: Velocity_out=sqrt(2*Ptotal_out/density)
Since density is proportional to 1/Temperature, increasing the temperature would increase Velocity_out and decrease the drag

Also, system packaging is vastly simplified. There is no need for a large axial compressor to compress and heat ram air to condition the air (i.e. to raise cold, ambient air above the minimum temperature required by the HTPEM) as in the case of the FIG. 1 HTPEM FC power system architecture. There also is no need for large tanks to store water for evaporative cooling, since the water needed for evaporative cooling is generated during flight.

Overall efficiency also is increased, due to the elimination of a large cooling compressor and the resulting power requirements of same and added drag of same.

The system can be controlled to provide appropriate levels of cooling for different flight conditions, and the efficiency of individual components can be adjusted to generate additional heat when required (e.g. a cold day) and controlled to not provide additional heat on a hot day. The system may bypass the turbine or even be combined with the EPS HEX for extra heating, if necessary.

According to aspect A of the disclosure there is provided an integrated hydrogen-electric power system for a propeller-driven aircraft, said integrated hydrogen-electric power system comprising: a hydrogen fuel source; an FC stack; an air compressor configured to introduce compressed air into a cathode side of the FC stack; a HEX configured to preheat ram air before entering the FC stack; an elongated shaft configured to support the air compressor and a turbine; wherein the HEX is configured to condense liquid water from a cathode exhaust stream from the FC stack; and a liquid water sprayer configured to spray condensed liquid water recovered from the cathode exhaust stream onto the FC stack to cool the FC stack by evaporative cooling.

In one embodiment of Aspect A, the integrated hydrogen-electric power system further comprises a water tank for storing at least some of the liquid water condensed by the heat exchanger.

In another embodiment of Aspect A, an anode exhaust stream and the cathode exhaust stream from the FC stack is passed to an ATO in which unreacted hydrogen in the anode exhaust stream is combusted, and an exhaust from the ATO is passed to the turbine in which energy contained in the exhaust from the ATO is extracted by the turbine.

In a further embodiment of Aspect A, an exhaust stream from the turbine is passed to the HEX to heat the ram air.

In another embodiment of Aspect A, the hydrogen-electric power system includes a propeller, wherein ram air from the propeller is passed to an inlet of the air compressor system.

In a further embodiment of Aspect A, the integrated hydrogen-electric power system comprises an electric propulsion system and a gear box, and further comprising a HEX for extracting waste heat from the EPS and/or the gear box.

In yet another embodiment of Aspect A, the EPS is configured to operate in an inefficient manner to generate waste heat.

In a further embodiment of Aspect A, the integrated hydrogen-electric power system further comprises a controller configured to control operation of the hydrogen-electric power system based on one or more conditions selected from the group consisting of FC stack temperature; FC stack voltage; FC stack cooling air inlet temperature; FC stack cooling air inlet humidity; ATO exhaust temperature; turbine exhaust temperature; ambient air humidity; ambient air external temperature; power demand of the propeller-driven aircraft; FC current; and stage of flight of the propeller-driven aircraft.

In yet another embodiment of Aspect A, the FC stack comprises a HTPEM FC stack.

In yet another embodiment of Aspect A, the HTPEM FC stack comprises porous bipolar plates configured for direct evaporative cooling by contact with the condensed liquid water.

According to Aspect B of the disclosure, there is provided an integrated hydrogen-electric power system for a propeller-driven aircraft, said integrated hydrogen-electric power system comprising: a hydrogen fuel source; an FC stack; a hydrogen gas preconditioner/air intercooler; an air compressor configured to introduce compressed air into a cathode side of the FC stack after passing through the hydrogen gas preconditioner/air intercooler; an EPS; a gear box; a HEX configured to extract heat from the EPS and/or the gear box, and to preheat ram air before entering the FC stack; an elongated shaft configured to support the air compressor and a turbine; and an ATO, wherein an anode exhaust stream and the cathode exhaust stream from the FC stack is passed to the ATO in which unreacted hydrogen in the anode exhaust stream is combusted, and an exhaust from the ATO is passed to the turbine in which energy contained in the exhaust from the ATO is extracted by the turbine.

According to one embodiment of Aspect B, an exhaust stream from the turbine is passed to cool the FC stack.

According to another embodiment of Aspect B, the hydrogen-electric power system includes a propeller, wherein ram air from the propeller is passed to an inlet of the air compressor.

In yet another embodiment of Aspect B, cooling air exhaust from the FC stack is passed to a nozzle in which energy contained in the cooling air exhaust is extracted by the nozzle.

In a further embodiment of Aspect B, the EPS is configured to operate in an inefficient manner to generate waste heat.

In yet another embodiment of Aspect B, the integrated hydrogen-electric power system further comprising a controller configured to control operation of the hydrogen-electric power system based on one or more conditions selected from the group consisting of FC stack temperature; FC stack voltage; FC stack cooling air inlet temperature; FC stack cooling air inlet humidity; ATO exhaust temperature; turbine exhaust temperature; ambient air humidity; ambient air external temperature; power demand of the propeller-driven aircraft; FC current; and stage of flight of the propeller-driven aircraft.

In still another embodiment of Aspect B, the FC stack comprises a HTPEM FC stack.

According to aspect C of the present invention there is provided an integrated hydrogen-electric power system for a propeller-driven aircraft, said integrated hydrogen-electric power system comprising:
a hydrogen fuel source;
   an FC stack;
   an air compressor configured to introduce compressed air into a cathode side of the FC stack;
   a heat exchanger configured to warm ram air for cooling the FC stack;
   an elongated shaft configured to support the air compressor system and a turbine;
   wherein the heat exchanger is configured to condense liquid water from a cathode exhaust stream from the FC stack; and
   a liquid water sprayer configured to spray condensed liquid water recovered from the cathode exhaust stream onto the FC stack to cool the FC stack by evaporative cooling.

Preferably the integrated hydrogen-electric power system of further comprises a water tank for storing at least some of the liquid water condensed by the heat exchanger.

Preferably an anode exhaust stream and the cathode exhaust stream from the FC stack is passed to an anode tail oxidizer in which unreacted hydrogen in the anode exhaust stream is combusted, and an exhaust from the anode tail oxidizer is passed to the turbine in which energy contained in the exhaust from the anode tail oxidizer is extracted by the turbine.

Preferably an exhaust stream from the turbine is passed to the heat exchanger to heat the ram air.

Preferably ram air from the propeller is passed to an inlet of the air compressor system.

Preferably the integrated hydrogen electric power system comprises an electric propulsion system and a gear box, and further comprising a heat exchanger for extracting waste heat from the electric propulsion system and/or the gear box.

Preferably the electric propulsion system is configured to operate in an inefficient manner to generate waste heat.

Preferably the integrated hydrogen-electric power system further comprises a controller configured to control operation of the hydrogen-electric engine based on one or more conditions selected from the group consisting of FC stack temperature; FC stack voltage; FC stack cooling air inlet temperature; FC stack cooling air inlet humidity; anode tail oxidizer exhaust temperature; turbine exhaust temperature; ambient air humidity; ambient air external temperature; power demand of the aircraft; FC current; and stage of flight of the aircraft.

Preferably the FC stack comprises a high temperature proton exchange membrane FC stack.

Preferably the high temperature proton exchange membrane FC stack comprises porous bipolar plates configured for direct evaporative cooling by contact with the condensed liquid water.

According to aspect D of the present invention there is provided an integrated hydrogen-electric power system for a propeller-driven aircraft, said integrated hydrogen-electric power system comprising:
a hydrogen fuel source;
an FC stack;
a hydrogen gas preconditioner/air intercooler;
an air compressor configured to introduce compressed air into a cathode side of the FC stack after passing through the hydrogen gas preconditioner/air intercooler;
an electric propulsion system;
a gear box;
a heat exchanger configured to extract heat from the electric propulsion system and/or the gear box, and to warm ram air for cooling the FC stack;
an elongated shaft configured to support the air compressor system and a turbine; and
an anode tail oxidizer, wherein an anode exhaust stream and the cathode exhaust stream from the FC stack is passed to an anode tail oxidizer in which unreacted hydrogen in the anode exhaust stream is combusted, and an exhaust from the anode tail oxidizer is passed to the turbine in which energy contained in the exhaust from the anode tail oxidizer is extracted by the turbine.

Preferably an exhaust stream from the turbine is passed to cool the FC stack.

Preferably ram air from the propeller is passed to an inlet of the air compressor system.

Preferably cooling air exhaust from the FC stack is passed to a nozzle in which energy contained in the cooling air exhaust is extracted by the nozzle.

Preferably the electric propulsion system is configured to operate in an inefficient manner to generate waste heat.

Preferably the integrated hydrogen-electric power system further comprises a controller configured to control operation of the hydrogen-electric engine based on one or more conditions selected from the group consisting of FC stack temperature; FC stack voltage; FC stack cooling air inlet temperature; FC stack cooling air inlet humidity; anode tail oxidizer exhaust temperature; turbine exhaust temperature; ambient air humidity; ambient air external temperature; power demand of the aircraft; FC current; and stage of flight of the aircraft.

Preferably the FC stack comprises a high temperature proton exchange membrane FC stack.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Further features and advantages of the disclosure will be seen in the following detailed description, taken in conjunction with the accompanying drawings, wherein like numerals depict like parts. The drawings described herein are for illustrative purposes only of selected embodiments and not all possible implementations and are not intended to limit the scope of the present disclosure.

In the drawings:

FIG. 1 is a schematic view of HTPEM FC power system;

FIG. 2 is a view similar to FIG. 1 of another HTPEM FC power system;

FIG. 3 is a view similar to FIG. 1 of still yet another HTPEM FC power system;

FIG. 4 is a schematic view of a HTPEM FC power system in accordance with a first embodiment of the present disclosure;

FIG. 5 is a schematic view of an alternative embodiment of an HTPEM FC power system in accordance with the present disclosure; and

FIG. 6 is a schematic view of an aircraft having a HTPEM FC power system in accordance with the present disclosure.

### DETAILED DESCRIPTION

Example embodiments will now be described more fully with reference to the accompanying drawings. Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, components, and/or groups, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers, and/or sections should not be limited by these terms. These terms may be only used to distinguish one element, component, region, layer or section from another element, component, region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

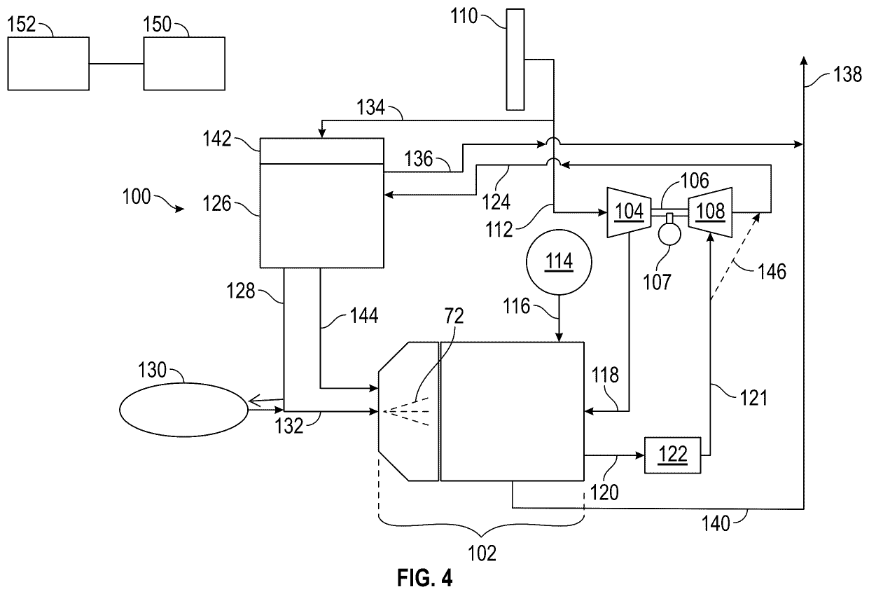

FIG. 4 illustrates a HTPEM FC power system architecture 100 for cooling an HTPEM FC stack 102 in accordance with a first embodiment of the present disclosure. HTPEM FC power system architecture 100 includes a compressor 104. Compressor 104 is electrically driven by electric motor 107, and is mechanically connected via a shaft 106 to a turbine 108. HTPEM FC power system 100 is configured to be carried on an aircraft and includes a propeller 110. Ram air from propeller 110 is passed via conduit 112 to compressor 104. H₂ is fed from an H₂ fuel tank 114 to an anode inlet 116 of HTPEM FC stack 102, where the H₂ is reacted with oxygen in air supplied to the cathode inlet 118 of the HTPEM FC stack 102 from compressor 104, to produce electricity. Depleted air and water vapor from the cathode exhaust and unreacted H₂ from the HTPEM FC stack 102 is passed via conduit 120 to an ATO 122 in which the unreacted H₂ in the anode exhaust is oxidized. The resulting exhaust from ATO 122, which includes moisture produced by oxidization of the H₂ in the ATO 122 as well as moisture in the cathode exhaust from HTPEM FC stack 102 is passed via ATO exhaust conduit 121 to turbine 108, in which some of the thermal energy contained in the exhaust from ATO 122 is recovered. The exhaust from turbine 108 is then passed via conduit 124 to HEX 126 wherein water vapor in the exhaust is condensed, and the condensed water vapor is passed via conduit 128 to water tank 130 or to nozzle 132 and sprayed on the HTPEM FC stack 102 to cool the HTPEM FC stack 102. Water tank 130 stores a quantity of liquid water which can be employed to cool the HTPEM FC stack 102 on start up and/or to supplement cooling during take off (TO) and climb. HEX 126 is cooled by ram air from the propeller 110 delivered via conduit 134. Dry air from HEX 126 is passed via conduit 136 and combined with cooling air exhaust from HTPEM FC stack 102 in line 140 and vented at outlet 138. HEX 126 may also include a heat exchanger 142 for harvesting thermal energy from the EPS and/or mechanical devices such as gear boxes (not shown) and the like that are commonly included in power trains for FC-powered aircraft.

Warm cooling air from HEX 126 is passed via conduit 144 to the cathode side of HTPEM FC stack 102.

A valved bypass 146 optionally may be included in ATO exhaust conduit 121 for selectively bypassing turbine 108 for cooling control.

Operation of HTPEM FC power system architecture 100 is controlled by a controller 150 which is configured to control operation of HTPEM FC power system architecture 100 by a measurement of HTPEM FC stack temperature, HTPEM FC stack cooling air inlet temperature and humidity, ATO and turbine exhaust temperature, ambient air humidity and mass flow and ambient external temperature, and stage of flight, from sensors 152, to achieve a desired temperature of the HTPEM FC stack 102.

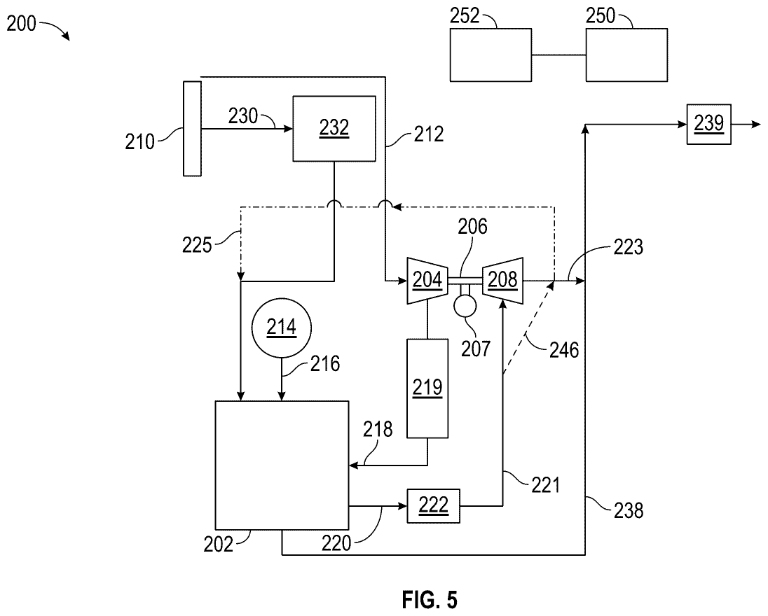

Referring to FIG. 5, there is illustrated an alternative HTPEM FC power system architecture 200 for cooling an HTPEM FC on an aircraft. HTPEM FC power system architecture 200 is similar to the FIG. 4 system architecture 100 in that it includes an HTPEM FC stack 202, and a compressor 204 which is driven by electric motor 207. Compressor 204 is also mechanically connected via a drive shaft 206 to a turbine 208. Compressor 204 is fed by ram air from propeller 210 delivered via conduit 212. H₂ gas is delivered from fuel tank 214 to the anode inlet 216 of HTPEM FC stack 202. Cooling air from compressor 204 is passed to the cathode inlet side 218 of HTPEM FC stack 202 after first passing through a H₂ preconditioner/cathode inter cooler 219. The H₂ is reacted with oxygen in the air supplied to the cathode inlet 216 to produce electricity. Depleted air and water vapor from the cathode exhaust and unreacted H₂ from the HTPEM FC stack 202 is passed via conduit 220 to ATO 222 in which unreacted H₂ in the anode exhaust is oxidized. The resulting exhaust from ATO 222, which includes moisture produced by oxidization of the H₂ in the ATO 222 as well as moisture produced in the cathode exhaust from the HTPEM FC stack 202 is passed via ATO exhaust conduit 221 to turbine 208 in which thermal energy contained in HTPEM FC stack exhaust and the ATO exhaust is recovered. As in the case of the FIG. 4 embodiment, a portion of the ATO exhaust in ATO exhaust conduit 221 may bypass turbine 208 via a valved bypass 246.

The exhaust from turbine 208 is passed via conduit 223 where it is mixed with cooling air exhaust from HTPEM FC stack 202 in conduit 238 and passed through a nozzle 239 in which energy contained in the HTPEM FC stack exhaust and the ATO bypass exhaust is by the nozzle, e.g., to generate thrust. Mixing the cool air exhaust from the HTPEM FC stack with the ATO bypass exhaust eliminates the need for a HEX between the turbine exhaust and the HTPEM FC cooling air.

A portion of ATO 222 exhaust is passed via bypass line 225 for mixture with cooling ram air 230 from propeller 210, after the cooling ram air 230 is first passed through an EPS and gear box HEX 232.

Completing HTPEM FC power system architecture 200 are a controller 250 which receives temperature and airflow reports including HTPEM FC stack temperature, HTPEM FC stack cooling air inlet temperature and humidity, ATO and turbine exhaust temperature, ambient air humidity and mass flow and ambient external temperature, and stage of flight, from sensors 252.

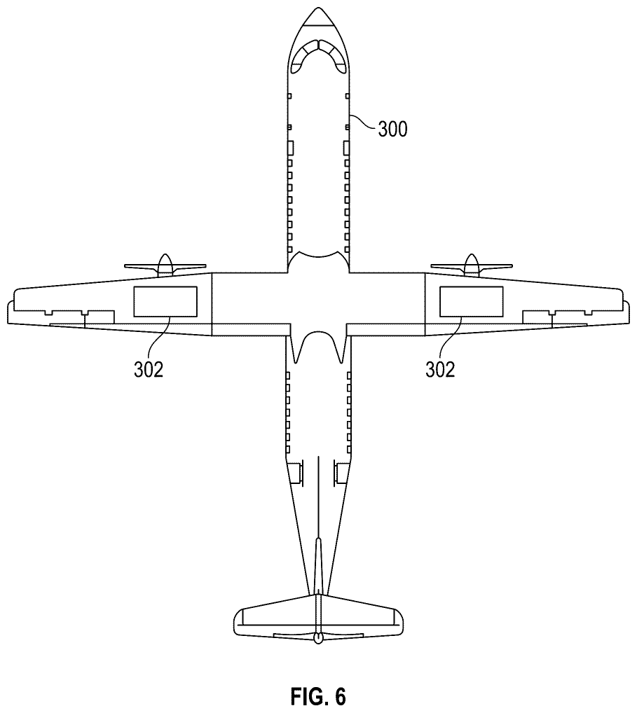

FIG. 6 illustrates an aircraft 300 including an HTPEM FC power system 302 in accordance with the present disclosure.

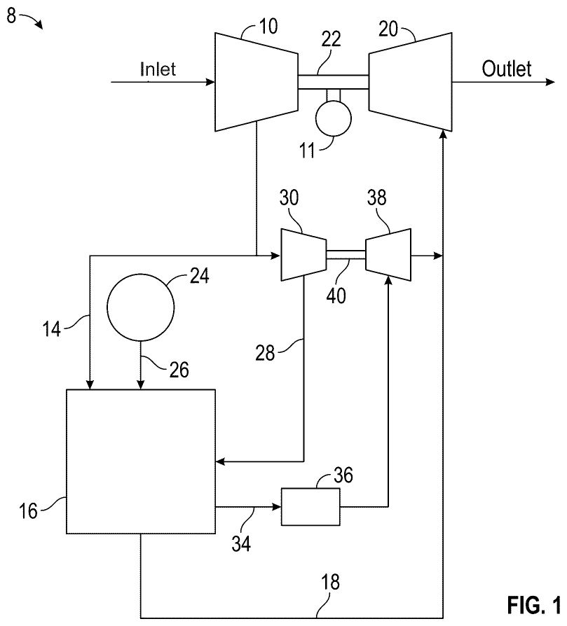

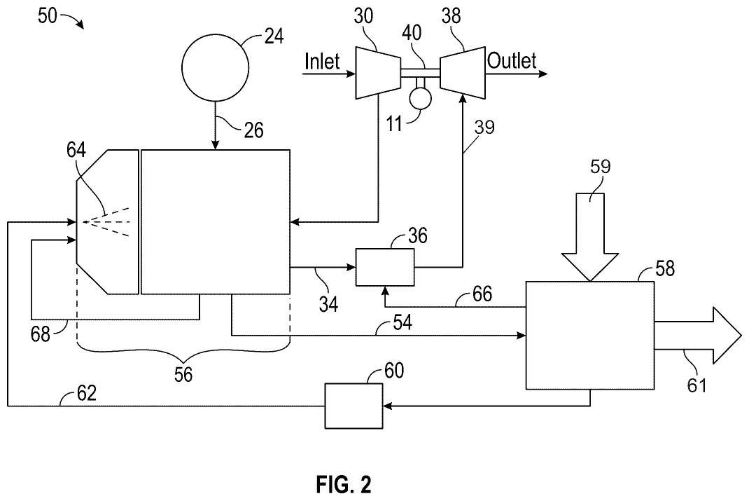

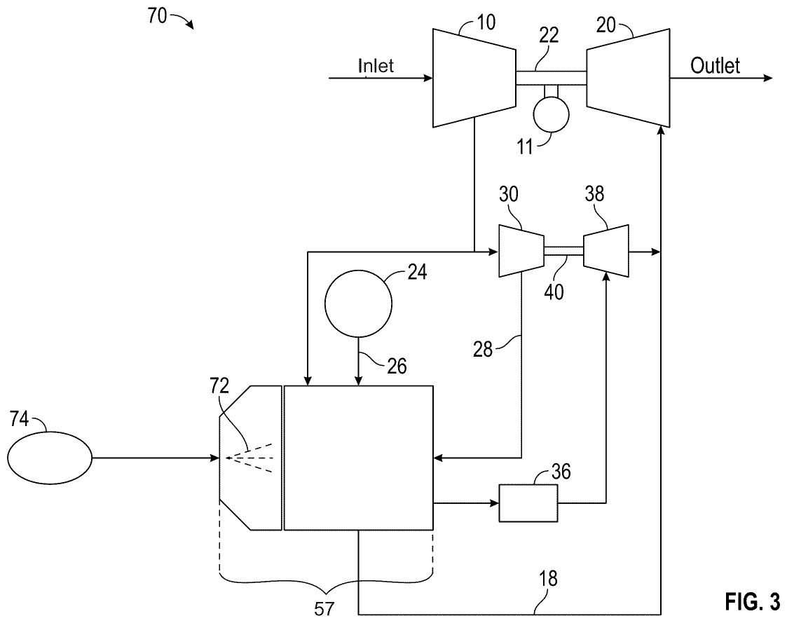

A feature and advantage of the system architecture of the present disclosure is that the system allows enthalpy to be harvested from the ATO exhaust. Another feature and advantage of the system architecture of the present disclosure is that we can control the harvesting to achieve a given temperature of exhaust to condition the cooling air delivered to the HTPEM FC stack to achieve a desired temperature. Also, the system architecture of the present disclosure is compact and efficient over a wide range of operating conditions and has the added benefit of employing moist air for cooling which increases the efficiency of cooling. Notwithstanding the relative complexity of the system architecture of the present disclosure, as compared to HTPEM FC power system architectures 8, 50, 70 as discussed above relative to FIGS. 1, 2 and 3, the system architecture 100, 200 of the present disclosure achieves superior performance compared to the HTPEM FC power system architectures 8, 50, 70 such as described above.

Yet an additional benefit of the system architectures 100, 200 of the current disclosure is that when HTPEM FC stack warming is needed, certain components such as the EPS can intentionally be operated in a non-efficient way to generate excess heat, which can be used to provide warming on a cold day, e.g., during startup.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Various changes and advantages may be made in the above disclosure without departing from the spirit and scope thereof.

### LIST OF REFERENCES

8 HTPEM FC power system architecture
10 compressor
11 electric motor
14 air inlet
16 HTPEM FC stack
18 air exhaust
20 turbine
22 shaft
24 H₂ fuel tank
26 anode inlet
28 cathode inlet
30 compressor
34 conduit
36 ATO
38 turbine
39 conduit
40 shaft
50 HTPEM FC power system architecture
54 cathode exhaust
56 HTPEM FC stack
57 HTPEM FC stack
58 heat exchanger (HEX)
59 cool free stream airflow
60 pump
61 hot free stream airflow
62 conduit
64 wastewater
66 exhaust
68 conduit
70 HTPEM FC power system architecture
72 cooling water
74 water tank
100 HTPEM FC power system architecture
102 HTPEM FC stack
104 compressor
106 shaft
107 electric motor
108 turbine
110 propeller
112 conduit
114 H₂ fuel tank
116 anode inlet
118 cathode inlet
120 conduit
121 ATO exhaust conduit
122 ATO
124 conduit
126 heat exchanger (HEX)
128 conduit
130 water tank
132 nozzle
134 conduit
136 conduit
138 outlet
140 line
142 EPS HEX
144 conduit
146 bypass
150 controller
152 sensors
200 HTPEM FC power system architecture
202 HTPEM FC stack
204 compressor
206 shaft
207 electric motor
208 turbine
210 propeller
212 conduit
214 fuel tank
216 anode inlet
218 cathode inlet
219 H₂ preconditioner/cathode intercooler
220 conduit
221 ATO exhaust conduit
222 ATO
223 conduit
225 bypass line
230 ram air
232 EPS and gear box HEX
238 conduit
239 nozzle
246 bypass
250 controller
252 sensors
300 aircraft
302 HTPEM FC power system

What is claimed:

1. An integrated hydrogen-electric power system for a propeller-driven aircraft, said integrated hydrogen-electric power system comprising:
a hydrogen fuel source;
an FC stack;
an air compressor configured to introduce compressed air into a cathode side of the FC stack;
a heat exchanger configured to preheat ram air before entering the FC stack;
an elongated shaft configured to support the air compressor system and a turbine;
wherein the heat exchanger is configured to condense liquid water from a cathode exhaust stream from the FC stack; and
a liquid water sprayer configured to spray condensed liquid water recovered from the cathode exhaust stream onto the FC stack to cool the FC stack by evaporative cooling.

2. The integrated hydrogen-electric power system of claim 1, further comprising a water tank for storing at least some of the liquid water condensed by the heat exchanger.

3. The integrated hydrogen-electric power system of claim 1, wherein an anode exhaust stream and the cathode exhaust stream from the FC stack is passed to an anode tail oxidizer in which unreacted hydrogen in the anode exhaust stream is combusted, and an exhaust from the anode tail oxidizer is passed to the turbine in which energy contained in the exhaust from the anode tail oxidizer is extracted by the turbine.

4. The integrated hydrogen-electric power system of claim 3, wherein an exhaust stream from the turbine is passed to the heat exchanger to heat the ram air.

5. The integrated hydrogen-electric power system of claim 1, wherein the hydrogen-electric power system includes a propeller, wherein ram air from the propeller is passed to an inlet of the air compressor system.

6. The integrated hydrogen-electric power system of claim 1, wherein the integrated hydrogen electric power system comprises an electric propulsion system and a gear box, and further comprising a heat exchanger for extracting waste heat from the electric propulsion system and/or the gear box.

7. The integrated hydrogen-electric power system of claim 6, wherein the electric propulsion system is configured to operate in an inefficient manner to generate waste heat.

8. The integrated hydrogen-electric power system of claim 1, further comprising a controller configured to control operation of the hydrogen-electric power system based on one or more conditions selected from the group consisting of FC stack temperature; FC stack voltage; FC stack cooling air inlet temperature; FC stack cooling air inlet humidity; anode tail oxidizer exhaust temperature; turbine exhaust temperature; ambient air humidity; ambient air external temperature; power demand of the propeller-driven aircraft; FC current; and stage of flight of the propeller-driven aircraft.

9. The integrated hydrogen-electric power system of claim 1, wherein the FC stack comprises a high temperature proton exchange membrane FC stack.

10. The integrated hydrogen-electric power system of claim 9, wherein the high temperature proton exchange membrane FC stack comprises porous bipolar plates configured for direct evaporative cooling by contact with the condensed liquid water.

11. An integrated hydrogen-electric power system for a propeller-driven aircraft, said integrated hydrogen-electric power system comprising:
a hydrogen fuel source;
an FC stack;
a hydrogen gas preconditioner/air intercooler;
an air compressor configured to introduce compressed air into a cathode side of the FC stack after passing through the hydrogen gas preconditioner/air intercooler;
an electric propulsion system;
a gear box;
a heat exchanger configured to extract heat from the electric propulsion system and/or the gear box, and to preheat ram air before entering the FC stack;
an elongated shaft configured to support the air compressor system and a turbine; and
an anode tail oxidizer, wherein an anode exhaust stream and the cathode exhaust stream from the FC stack is passed to the anode tail oxidizer in which unreacted hydrogen in the anode exhaust stream is combusted, and an exhaust from the anode tail oxidizer is passed to the turbine in which energy contained in the exhaust from the anode tail oxidizer is extracted by the turbine.

12. The integrated hydrogen-electric power system of claim 11, wherein an exhaust stream from the turbine is passed to cool the FC stack.

13. The integrated hydrogen-electric power system of claim 11, wherein the hydrogen-electric power system includes a propeller, wherein ram air from the propeller is passed to an inlet of the air compressor.

14. The integrated hydrogen-electric power system of claim 11, wherein cooling air exhaust from the FC stack is passed to a nozzle in which energy contained in the cooling air exhaust is extracted by the nozzle.

15. The integrated hydrogen-electric power system of claim 11, wherein the electric propulsion system is configured to operate in an inefficient manner to generate waste heat.

16. The integrated hydrogen-electric power system of claim 11, further comprising a controller configured to control operation of the hydrogen-electric engine based on one or more conditions selected from the group consisting of FC stack temperature; FC stack voltage; FC stack cooling air inlet temperature; FC stack cooling air inlet humidity; anode tail oxidizer exhaust temperature; turbine exhaust temperature; ambient air humidity; ambient air external temperature; power demand of the aircraft; FC current; and stage of flight of the propeller-driven aircraft.

17. The integrated hydrogen-electric power system of claim 11, wherein the FC stack comprises a high temperature proton exchange membrane FC stack.
